(19) United States
(12) Patent Application Publication
(10) Pub. No.: US 2026/0176196 A1
(43) Pub. Date: Jun. 25, 2026

(54) CEMENT COMPOSITION AND HYDRAULIC COMPOSITION

(71) Applicant: TAIHEIYO CEMENT CORPORATION, Tokyo (JP)

(72) Inventors: Kazuki Kobayashi, Tokyo (JP); Yoshifumi Ohgi, Tokyo (JP); Masayuki Hashimoto, Tokyo (JP); Yoshifumi Hosokawa, Tokyo (JP)

(21) Appl. No.: 19/132,661

(22) PCT Filed: Dec. 12, 2023
(86) PCT No.: PCT/JP2023/044385

§ 371 Date: May 23, 2025

(30) Foreign Application Priority Data
Dec. 13, 2022 (JP) 2022-198715
Dec. 16, 2022 (JP) 2022-200929

(51) Int. Cl. C04B 7/02; C04B 24/12; C04B 28/04; C04B 28/18; C04B 40/00; C04B 40/02; C04B 111/00

(52) U.S. Cl. CPC C04B 7/02; C04B 24/121; C04B 28/04; C04B 28/188; C04B 40/0042; C04B 40/0231; C04B 2111/00215

(57) ABSTRACT

A cement composition including, a cement admixture exhibiting excellent strength developability, capable of reducing the total amount of carbon dioxide emitted by absorbing and fixing a large amount of carbon dioxide during a curing process; and a hydraulic composition including the cement composition. A cement composition comprising: (A) a powdery cement-containing material containing (i) Portland cement or a ground product of Portland cement clinker, and (ii) a ground product of a fired product that contains 2CaO·SiO₂ and 2CaO·Al₂O₃·SiO₂.

### TECHNICAL FIELD

The present invention relates to a cement composition and a hydraulic composition including the cement composition.

### BACKGROUND ART

Currently, reduction of carbon dioxide emissions is important issue for suppressing global warming.

As a method of reducing carbon dioxide emissions in production of a cementitious hardened materials, there has been known a method of reducing the total amount of carbon dioxide emitted until the cementitious hardened materials is obtained, by absorbing carbon dioxide during a curing process of the cementitious hardened materials.

In Patent Literature 1, there is a description of a cementitious hardened materials characterized by being obtained by carbonating a hardened materials of a cement kneaded product containing: (A) a powdery cement composition that contains cement mixing powder containing one or both of mullite and anorthite, and Portland cement; (B) water; and (C) aggregate as a cementitious hardened materials capable of significantly reducing the total amount of carbon dioxide emitted by absorbing a large amount of carbon dioxide during a curing process.

In Patent Literature 2, there is a description of a cementitious hardened materials characterized by being obtained by carbonating a hardened materials of a cement kneaded product containing the following materials: (A) a powdery cement composition containing a ground product of a fired product containing 10 parts by mass to 200 parts by mass of C₂AS with respect to 100 parts by mass of C₂S and having a content of C₃A of 20 parts by mass or less, and Portland cement; (B) water; and (C) aggregate as a cementitious hardened materials capable of significantly reducing the total amount of carbon dioxide emitted by absorbing a large amount of carbon dioxide during a curing process, and exhibiting a small reduction rate in compressive strength as compared to that of a reference case where a powder material is entirely formed of Portland cement.

A cement composition using a ground product (excluding a ground product of cement clinker) of a fired product has been known as a cement admixture.

For example, in Patent Literature 3, there is a description of a fired product characterized by containing from 10 parts by weight to 100 parts by weight of C₂AS with respect to 100 parts by weight of C₂S and having a content of C₃A of 20 parts by weight or less as a fired product (cement admixture) capable of decreasing the hydration heat of cement and providing satisfactory fluidity thereof.

### CITATION LIST

### Patent Literature

[PTL 1] JP 2016-153357 A
[PTL 2] JP 2016-47788 A
[PTL 3] JP 2004-2155 A

### SUMMARY OF INVENTION

### Technical Problem

An object of the present invention is to provide: a cement composition including, as a cement admixture, a ground product (excluding a ground product of cement clinker) of a fired product, exhibiting excellent strength developability, and capable of reducing the total amount of carbon dioxide emitted by absorbing and fixing a large amount of carbon dioxide during a curing process; and a hydraulic composition including the cement composition.

### Solution to Problem

The inventors of the present invention have made extensive investigations in order to achieve the above-mentioned object. As a result, the inventors have found that the object can be achieved by a cement composition including: (A) a powdery cement-containing material containing (i) Portland cement or a ground product of Portland cement clinker and (ii) a ground product of a fired product that contains 2CaO·SiO₂ and 2CaO·Al₂O₃·SiO₂ and satisfies specific conditions; and (B) (iii) an amine. Thus, the inventors have completed the present invention.

That is, the present invention provides the following items [1] to [15].
[1]A cement composition, including: (A) a powdery cement-containing material containing (i) Portland cement or a ground product (pulverized product) of Portland cement clinker, and (ii) a ground product of a fired product that contains 2CaO·SiO₂ and 2CaO·Al₂O₃·SiO₂ and satisfies the following conditions (1) and (2); and (B) (iii) an amine:
(1) an amount of the 2CaO·Al₂O₃·SiO₂ is from 10 parts by mass to 100 parts by mass with respect to 100 parts by mass of the 2CaO·SiO₂; and
(2) the fired product is free of 3CaO·Al₂O₃ or contains 3CaO·Al₂O₃ in an amount of 15 parts by mass or less with respect to 100 parts by mass of the 2CaO·SiO₂.
[2] The cement composition according to the above-mentioned item [1], wherein the powdery cement-containing material contains (iv) an alkaline earth metal-containing material, and wherein a content ratio of an alkaline earth metal in the powdery cement-containing material is from 0.1 mass % to 10 mass % in terms of oxide, provided that only magnesium oxide, magnesium hydroxide, calcium oxide, and calcium hydroxide are included as the alkaline earth metal other than the alkaline earth metal included in the alkaline earth metal-containing material.
[3] The cement composition according to the above-mentioned item [1] or [2], wherein an amount of the amine is from 0.001 part by mass to 5.0 parts by mass with respect to 100 parts by mass of the powdery cement-containing material.
[4] The cement composition according to any one of the above-mentioned items [1] to [3], wherein the amine is an alkanolamine.
[5] The cement composition according to any one of the above-mentioned items [1] to [4], wherein a content ratio of the ground product of the fired product in the powdery cement-containing material is from 10 mass %, to 90 mass %.
[6]A cement composition, including: (i) Portland cement or a ground product of Portland cement clinker; (ii) a ground product of a fired product that contains 2CaO·SiO₂ and 2CaO·Al₂O₃·SiO₂ and satisfies the following conditions (1) and (2); and (iv) an alkaline earth metal-containing material, wherein a content ratio of an alkaline earth metal in the cement composition is from 0.1 mass % to 10 mass % in terms of oxide, provided that only magnesium oxide, magnesium hydroxide, calcium oxide, and calcium hydroxide are included as the alkaline earth metal other than the alkaline earth metal included in the alkaline earth metal-containing material:
(1) an amount of the 2CaO·Al₂O₃·SiO₂ is from 10 parts by mass to 100 parts by mass with respect to 100 parts by mass of the 2CaO·SiO₂; and
(2) the fired product is free of 3CaO·Al₂O₃ or contains 3CaO·Al₂O₃ in an amount of 15 parts by mass or less with respect to 100 parts by mass of the 2CaO·SiO₂.
[7] The cement composition according to the above-mentioned item [6], wherein a content ratio of the ground product of the fired product in the cement composition is from 10 mass % to 90 mass %.
[8] The cement composition according to the above-mentioned item [6] or [7], wherein the alkaline earth metal is magnesium (Mg).
[9] The cement composition according to any one of the above-mentioned items [6] to [8], wherein the alkaline earth metal is calcium (Ca).
[10]A hydraulic composition, including: the cement composition of any one of the above-mentioned items [1] to [5]; water; and aggregate, wherein an amount of the water is from 25 parts by mass to 70 parts by mass with respect to 100 parts by mass of the powdery cement-containing material.
[11] The hydraulic composition according to the above-mentioned item [10], wherein the hydraulic composition is a carbonated hardened materials (hardened body) obtained through carbonation curing.
[12]A hydraulic composition, including: the cement composition of any one of the above-mentioned items [6] to [9]; water; and aggregate, wherein an amount of the water is from 25 parts by mass to 70 parts by mass with respect to 100 parts by mass of the cement composition.
[13] The hydraulic composition according to the above-mentioned item [12], wherein the hydraulic composition is a carbonated hardened materials obtained through carbonation curing.
[14]A method of producing the hydraulic composition of the above-mentioned item [11], the method including: a kneaded product preparing step of preparing a kneaded product by using materials for forming the cement composition, the water, and the aggregate, the kneaded product being a mixture thereof; a placing step of placing the kneaded product into formwork; a removing step of removing a hardened materials of the kneaded product from the formwork after the kneaded product in the formwork is hardened; and a carbonation curing step of subjecting the hardened materials of the kneaded product removed from the formwork to carbonation curing to provide the carbonated hardened materials.
[15]A method of producing the hydraulic composition of the above-mentioned item [13], the method including: a kneaded product preparing step of preparing a kneaded product by using materials for forming the cement composition, the water, and the aggregate, the kneaded product being a mixture thereof; a placing step of placing the kneaded product into formwork; a removing step of removing a hardened materials of the kneaded product from the formwork after the kneaded product in the formwork is hardened; and a carbonation curing step of subjecting the hardened materials of the kneaded product removed from the formwork to carbonation curing to provide the carbonated hardened materials.

### Advantageous Effects of Invention

The cement composition of the present invention exhibits excellent strength developability when water is added to the cement composition to form a hardened materials thereof.

The cement composition of the present invention is subjected to carbonation curing or the like during a curing process when water is added to the cement composition to form a hardened materials thereof. Thus, the cement composition is capable of reducing the total amount of carbon dioxide emitted by absorbing and fixing a large amount of carbon dioxide.

By adjusting the raw material composition of (ii) the ground product of the fired product for forming the cement composition of the present invention to reduce the content ratio of CaO as compared to that of Portland cement, carbon dioxide emissions during production of the cement composition can be reduced. In addition, by setting the firing temperature during production of the fired product to be lower than the firing temperature during production of Portland cement, carbon dioxide emissions from a fuel for firing can be reduced.

### DESCRIPTION OF EMBODIMENTS

### [Cement Composition A]

An example of a cement composition of the present invention is a cement composition (hereinafter also referred to as “cement composition A”) including: (A) a powdery cement-containing material containing (i) Portland cement or a ground product of Portland cement clinker, and (ii) a ground product of a fired product that contains 2CaO·SiO₂ (hereinafter also referred to as “C₂S”) and 2CaO·Al₂O₃·SiO₂ (hereinafter also referred to as “C₂AS”) and satisfies the following conditions (1) and (2); and (B) (iii) an amine.
(1) The amount of the 2CaO·Al₂O₃·SiO₂ is from 10 parts by mass to 100 parts by mass with respect to 100 parts by mass of the 2CaO·SiO₂.
(2) The fired product is free of 3CaO·Al₂O₃ (hereinafter also referred to as “C₃A”) or contains 3CaO·Al₂O₃ in an amount of 15 parts by mass or less with respect to 100 parts by mass of the 2CaO·SiO₂.

Details thereof are described below.

### [Component (A): Powdery Cement-Containing Material]

The powdery cement-containing material contains: (i) Portland cement or a ground product of Portland cement clinker; and (ii) a ground product of a fired product that contains 2CaO·SiO₂ and 2CaO·Al₂O₃·SiO₂ and satisfies the above-mentioned conditions (1) and (2).

### [Component (i): Portland Cement or Ground Product of Portland Cement Clinker]

Examples of the Portland cement include various Portland cements, such as ordinary Portland cement, high-early-strength Portland cement, moderate-heat Portland cement, and low-heat Portland cement.

Examples of the ground product of Portland cement clinker include ground products of clinkers of the various Portland cements described above.

Those components may be used alone or in combination thereof.

Of those, ordinary Portland cement or a ground product of ordinary Portland cement clinker is preferred from viewpoints of cost, versatility, and the like. A Blaine specific surface area of the Portland cement or the ground product of Portland cement clinker is preferably from 2,500 cm²/g to 5,000 cm²/g, more preferably from 3,000 cm²/g to 4,500 cm²/g. When the Blaine specific surface area is 2,500 cm²/g or more, strength developability of the cement composition is further improved. When the Blaine specific surface area is 5,000 cm²/g or less, fluidity of the cement composition before hardening is further improved.

The content ratio of the Portland cement or the ground product of Portland cement clinker in the powdery cement-containing material is preferably from 10 mass to 70 mass %, more preferably from 15 mass % to 60 mass %, still more preferably from 20 mass % to 50 mass %, particularly preferably from 25 mass % to 40 mass %. When the content ratio is 10 mass % or more, strength of a hardened materials of a hydraulic composition can be further increased. When the content ratio is 60 mass % or less, the content ratio of (ii) the ground product of the fired product is further increased, and hence the reduction of carbon dioxide emissions described above can be still further achieved.

The content ratio of the Portland cement or the ground product of Portland cement clinker in the cement composition A is preferably from 10 mass % to 70 mass %, more preferably from 15 mass % to 60 mass %, still more preferably from 20 mass % to 50 mass %, particularly preferably from 25 mass % to 40 mass %. When the content ratio is 10 mass % or more, the strength of the hardened materials can be further increased. When the content ratio is 60 mass % or less, the content ratio of (ii) the ground product of the fired product is further increased, and hence the reduction of carbon dioxide emissions described above can be still further achieved.

[Component (ii): Ground Product of Fired Product containing C₂S and C₂AS]

In a fired product containing C₂S and C₂AS (hereinafter also simply referred to as “fired product”), the amount of C₂AS is from 10 parts by mass to 100 parts by mass, preferably from 20 parts by mass to 80 parts by mass, more preferably from 25 parts by mass to 70 parts by mass, particularly preferably from 30 parts by mass to 60 parts by mass with respect to 100 parts by mass of C₂S. Carbonation of a hydraulic composition (e.g., mortar) of a fired product having an amount of C₂AS of less than 10 parts by mass hardly progresses during carbonation curing, and the amount of carbon dioxide absorbed by a hydraulic composition at an early age decreases. When the amount of C₂AS is more than 100 parts by mass, the amount of C₂S decreases relatively. Thus, the strength developability of the cement composition decreases, and the amount of carbon dioxide absorbed by a hydraulic composition at a late age decreases.

When the fired product contains C₃A, the amount of C₃A is 15 parts by mass or less, preferably from 0.1 part by mass to 10 parts by mass, more preferably from 0.5 part by mass to 5 parts by mass, particularly preferably from 1 part by mass to 3 parts by mass with respect to 100 parts by mass of C₂S. A fired product having an amount of C₃A of more than 15 parts by mass is difficult to produce. In addition, when the amount of C₃A is 15 parts by mass or less, the fluidity of a hydraulic composition before hardening is further improved.

The fired product may contain 4CaO·Al₂O₃·Fe₂O₃ (hereinafter also referred to as “C₄AF”).

The amount of C₄AF is preferably 30 parts by mass or less, more preferably from 0.1 part by mass to 20 parts by mass, still more preferably from 0.5 part by mass to 15 parts by mass, particularly preferably from 1.0 part by mass to 10 parts by mass with respect to 100 parts by mass of C₂S. When the amount of C₄AF is 30 parts by mass or less, hydration activity of a hydraulic composition at an early age can be further improved.

The total amount of C₄AF and C₂AS is preferably from 10 parts by mass to 100 parts by mass, more preferably from 20 parts by mass to 90 parts by mass, particularly preferably from 30 parts by mass to 80 parts by mass with respect to 100 parts by mass of C₂S. Carbonation of a hydraulic composition (e.g., mortar) of a fired product having a total amount of C₄AF and C₂AS of 10 parts by mass or more easily progresses during carbonation curing, and the amount of carbon dioxide absorbed by a hydraulic composition at an early age is further increased. When the total amount of C₄AF and C₂AS is 100 parts by mass or less, the amount of C₂S increases relatively. Thus, the strength developability of the cement composition is further improved, and the amount of carbon dioxide absorbed by a hydraulic composition at a late age is further increased.

The amount of C₄AF is preferably 210 parts by mass or less, more preferably 100 parts by mass or less, still more preferably 50 parts by mass or less, particularly preferably 20 parts by mass or less with respect to 100 parts by mass of C₂AS. When the amount of C₄AF is 210 parts by mass or less, the hydration activity of a hydraulic composition at an early age can be further improved.

The content ratio of C₂S (belite) in the fired product is preferably from 50 mass % to 80 mass %, more preferably from 55 mass % to 75 mass %, particularly preferably from 60 mass %, to 70 mass %. When the content ratio is 50 mass % or more, long-term strength developability of the cement composition is further improved. When the content ratio is 80 mass % or less, initial strength developability of the cement composition is further improved.

The content ratio of C₂AS in the fired product is preferably from 10 mass % to 60 mass %, more preferably from 20 mass % to 50 mass %, particularly preferably from 25 mass % to 40 mass %. When the content ratio is 10 mass % or more, carbonation of a hydraulic composition easily progresses, and the amount of carbon dioxide absorbed by a hydraulic composition at an early age is further increased. When the content ratio is 60 mass % or less, the amount of C₂S increases relatively. Thus, the strength developability of the cement composition is further improved, and the amount of carbon dioxide absorbed by a hydraulic composition at a late age is further increased.

The content ratio of C₃A (aluminate phase) in the fired product is preferably 10 mass % or less, more preferably from 0.1 mass % to 5 mass %, particularly preferably from 0.5 mass % to 3.5 mass %. When the content ratio is 10 mass % or less, the fluidity of a hydraulic composition before hardening is further improved.

The content ratio of C₄AF (ferrite phase) in the fired product is preferably 20 mass % or less, more preferably 10 mass % or less, particularly preferably 5 mass % or less. When the content ratio is 20 mass % or less, the hydration activity of a hydraulic composition at an early age can be further improved.

The content ratio of C₃S (alite: 3CaO·SiO₂) in the fired product is preferably 5 mass % or less, more preferably 3 mass % or less, particularly preferably 1 mass % or less. When the content ratio is 5 mass % or less, the fluidity of a hydraulic composition before hardening can be further improved.

The content ratio of CaO in the fired product (in particular, in a case where limestone is used as a raw material) is preferably from 50 mass % to 59 mass %, more preferably from 52 mass % to 58 mass %, particularly preferably from 53 mass % to 57 mass %. When the content ratio is 50 mass % or more, the strength developability of the cement composition is improved. When the content ratio is 59 mass % or less, carbon dioxide emissions during firing can be further reduced.

The content ratio of SiO₂ in the fired product is preferably from 15 mass % to 45 mass %, more preferably from 20 mass % to 40 mass %, particularly preferably from 25 mass to 35 mass %.

The content ratio of Al₂O₃ in the fired product is preferably from 1 mass % to 10 mass %, more preferably from 3 mass % to 9 mass %, particularly preferably from 4 mass % to 8 mass %.

The content ratio of Fe₂O₃ in the fired product is preferably from 1 mass % to 8 mass %, more preferably from 2 mass % to 6 mass %, particularly preferably from 3 mass to 5 mass %.

The mineral composition (content ratios of C₂S, C₂AS, C₃A, C₄AF, and the like) of the fired product may be determined by subjecting the fired product to an X-ray diffraction (XRD)/Rietveld method or the like. Specifically, the mineral composition may be determined through Rietveld analysis in which a theoretical profile of each mineral is fitted to a powder X-ray diffraction chart (actually measured profile) of the fired product. Commercially available analysis software may be used for the determination. The mineral composition may also be determined by, for example, point counting using microscopic observation or electron backscatter diffraction.

The fired product described above may be produced by, for example, using one or more kinds selected from industrial waste, general waste, construction-generated soil, and the like as a raw material, preparing the raw material so as to achieve the target mineral composition, chemical composition, or the like of the fired product, and then firing the raw material at, for example, from 1,000° C. to 1,400° C. (preferably from 1,200° C. to 1,400° C., more preferably from 1,300° C. to 1,400° C.).

When it is difficult to prepare a fired product having target numerical values for its mineral composition by using only the above-mentioned raw materials, raw materials, such as a calcium raw material (e.g., limestone), a silicon raw material, an aluminum raw material, and an iron raw material, may be used.

The obtained fired product is appropriately ground with a pulverizer, such as a ball mill or a rod mill, for example. When the powdery cement-containing material contains gypsum, the fired product and gypsum may be simultaneously ground and mixed. The Blaine specific surface area of the fired product is preferably from 2,500 cm/g to 5,000 cm²/g, more preferably from 3,000 cm²/g to 4,500 cm²/g. When the Blaine specific surface area is 2,500 cm²/g or more, a hydration reaction is further accelerated, the amount of carbon dioxide absorbed is further increased, and the strength developability of the cement composition is further improved. When the Blaine specific surface area is 5,000 cm²/g or less, the fluidity of a hydraulic composition before hardening is further improved.

The content ratio of the ground product of the fired product in the powdery cement-containing material is preferably from 10 mass % to 90 mass %, more preferably from 30 mass % to 85 mass %, still more preferably from 40 mass % to 80 mass %, still more preferably from 50 mass % to 80 mass %, particularly preferably from 60 mass % to 80 mass %. When the content ratio is 10 mass % or more, the amount of carbon dioxide absorbed by a hydraulic composition at an early age is further increased. When the content ratio is 90 mass % or less, degradation in strength developability of the cement composition resulting from a relatively smaller amount of the Portland cement or the ground product of Portland cement clinker is less liable to occur.

The amount of the ground product of the fired product is preferably from 65 parts by mass to 500 parts by mass, more preferably from 100 parts by mass to 400 parts by mass, still more preferably from 150 parts by mass to 350 parts by mass, particularly preferably from 200 parts by mass to 320 parts by mass with respect to 100 parts by mass of the Portland cement or the ground product of Portland cement clinker. When the amount is 65 parts by mass or more, the amount of carbon dioxide absorbed by a hydraulic composition at an early age is further increased. When the amount is 500 parts by mass or less, degradation in strength developability of the cement composition resulting from a relatively smaller amount of the Portland cement or the ground product of Portland cement clinker is less liable to occur.

The content ratio of the ground product of the fired product in the cement composition is preferably from 10 mass % to 90 mass %, more preferably from 30 mass % to 85 mass %, still more preferably from 40 mass % to 80 mass %, still more preferably from 50 mass % to 80 mass %, particularly preferably from 60 mass %, to 80 mass %. When the content ratio is 10 mass % or more, the amount of carbon dioxide absorbed by a hydraulic composition at an early age is further increased. When the content ratio is 90 mass % or less, degradation in strength developability of the cement composition resulting from a relatively smaller amount of the Portland cement or the ground product of Portland cement clinker is less liable to occur.

The ratio of the total amount of the component (i) and the component (ii) in the powdery cement-containing material (A) is preferably 80 mass % or more, more preferably 90 mass % or more, particularly preferably 95 mass or more from the viewpoints of improving the strength developability of the cement composition and further increasing the amount of carbon dioxide absorbed therein.

### [Component (iv): Alkaline Earth Metal-Containing Material]

The powdery cement-containing material may contain (iv) an alkaline earth metal-containing material. When the powdery cement-containing material contains the alkaline earth metal-containing material, the strength developability of the cement composition can be further improved.

Examples of an alkaline earth metal included in the alkaline earth metal-containing material include calcium (Ca), magnesium (Mg), strontium (Sr), barium (Ba), radium (Ra), and beryllium (Be). Those alkaline earth metals may be included alone or in combination thereof.

Of those, calcium (Ca) and magnesium (Mg) are preferred, and magnesium (Mg) is more preferred from the viewpoints of the strength developability of the cement composition, easy availability, and the like.

The form of the alkaline earth metal included in the cement composition is preferably an oxide of the alkaline earth metal or a hydroxide of the alkaline earth metal, more preferably an oxide of the alkaline earth metal from the viewpoint of improving the strength developability of the cement composition.

When the alkaline earth metal-containing material contains magnesium as the alkaline earth metal, examples of a magnesium source (magnesium-containing substance) include magnesium oxide, magnesium hydroxide, magnesium sulfate, magnesium nitrate, and magnesium chloride. Of those, magnesium oxide and magnesium hydroxide are preferred, and magnesium oxide is more preferred from the viewpoint of further improving the strength developability of the cement composition.

The magnesium source may be a reagent, but may be a magnesium-containing substance, such as periclase (a mineral containing magnesium oxide), light-burned magnesia (MgO), a partially hydrated product of light-burned magnesia, light-burned dolomite (CaO·MgO), and a partially hydrated product of light-burned dolomite. Those magnesium sources may be used alone or in combination thereof.

When the alkaline earth metal-containing material contains calcium as the alkaline earth metal, examples of a calcium source (calcium-containing material) include calcium oxide, calcium hydroxide, calcium nitrate, and calcium chloride. The calcium source may be a reagent, but may be a calcium-containing substance, such as quicklime, slaked lime, fresh concrete sludge, or waste concrete. Those calcium sources may be used alone or in combination thereof. Of those, calcium oxide and calcium hydroxide are preferred, and calcium oxide is more preferred from the viewpoint of further improving the strength developability of the cement composition.

The fresh concrete sludge is preferably powdery sludge collected as fine powder containing hydrated cement and unhydrated cement by sieving sludge generated during a concrete production process in a fresh concrete plant or a concrete product plant with a sieve or the like. The fresh concrete sludge is easily carbonated and typically has a content ratio of CaO of 30 mass % or more.

The waste concrete is preferably fine powdery waste concrete containing hydrated cement and unhydrated cement, which is obtained by pulverizing concrete waste generated during demolition of a concrete structure or the like and then removing aggregate from the ground product. The waste concrete fine powder is easily carbonated and typically has a content ratio of CaO of 15 mass % or more.

The alkaline earth metal-containing material is typically powdery from the viewpoint of, for example, improving the strength developability of a hydraulic composition.

The content ratio of an alkaline earth metal (provided that only magnesium oxide, magnesium hydroxide, calcium oxide, and calcium hydroxide are included as the alkaline earth metal other than the alkaline earth metal included in the alkaline earth metal-containing material (in other words, alkaline earth metals included in a material other than the alkaline earth metal-containing material included in the powdery cement-containing material)) in the powdery cement-containing material is from 0.1 mass % to 10 mass %, more preferably from 0.2 mass % to 8 mass %, particularly preferably from 0.5 mass % to 6 mass % in terms of oxide. When the content ratio thereof is less than 0.1 mass %, the strength developability of the cement composition is degraded. When the content ratio thereof is more than 10 mass %, the initial strength developability (e.g., at an age of 1 day) of the cement composition may be degraded.

When the powdery cement-containing material contains a plurality of alkaline earth metals (provided that only magnesium oxide, magnesium hydroxide, calcium oxide, and calcium hydroxide are included as the alkaline earth metal other than the alkaline earth metal included in the alkaline earth metal-containing material), the content ratio is the total of the content ratios of the plurality of alkaline earth metals.

Periclase (MgO), magnesium hydroxide (Mg(OH)₂), calcium oxide (CaO, in particular, free calcium oxide), calcium hydroxide (Ca(OH)₂), and the like may be included in the above-mentioned components (i) and (ii), components (v) and (vi) (described later), and the like. The content ratio of the alkaline earth metal includes the content ratios of the alkaline earth metals described above in addition to the content ratio of the alkaline earth metal included in the alkaline earth metal-containing material.

Alkaline earth metals (e.g., calcium) dissolved as solid solutions in silicate minerals (e.g., belite and alite), an aluminate phase, and a ferrite phase, and alkaline earth metals (alkaline earth metals other than magnesium oxide, magnesium hydroxide, calcium oxide, and calcium hydroxide), such as gypsum (CaSO₄) and calcium carbonate, included in the components (i) to (ii) and the components (v) and (vi) do not affect the effects of the present invention, or are in very small amounts and thus have hardly any impact on the effects of the present invention.

The content ratios of periclase (MgO) and magnesium hydroxide (Mg(OH)₂) included in the components (i) and (ii), the components (v) and (vi), and the like may be measured by an X-ray diffraction (XRD)/Rietveld method or the like.

The content ratio of calcium oxide (CaO) or calcium hydroxide (Ca(OH)₂) included in the components (i) and (ii), the components (v) and (vi), and the like may be measured by an X-ray diffraction (XRD)/Rietveld method or the like, or in conformity with “JCAS I-01-1997 (Determination method for free calcium oxide).”

When magnesium is included as the alkaline earth metal, the content ratio of magnesium in the powdery cement-containing material is preferably from 1.0 mass % to 10 mass %, more preferably from 2.5 mass to 8.0 mass %, particularly preferably from 4.0 mass % to 6.0 mass % in terms of oxide. When the content ratio is 1.0 mass % or more, the strength developability of the cement composition is further improved. When the content ratio is more than 10 mass %, the initial strength developability (e.g., at an age of 1 day) of the cement composition may be degraded.

When calcium is included as the alkaline earth metal, the content ratio of calcium in the powdery cement-containing material is preferably from 0.8 mass % to 10 mass %, more preferably from 1.0 mass % to 4.0 mass %, still more preferably from 1.2 mass % to 3.0 mass %, particularly preferably from 1.5 mass % to 2.0 mass % in terms of oxide. When the content ratio is 0.8 mass or more, the strength developability of the cement composition is further improved. When the content ratio is more than 10.0 mass %, the initial strength developability (e.g., at an age of 1 day) of the cement composition may be degraded.

### [Component (v): Gypsum]

The content ratio of SO₃ in the powdery cement-containing material is preferably 6.0 mass % or less, more preferably from 0.5 mass % to 5.0 mass %, still more preferably from 1.0 mass % to 4.5 mass %, particularly preferably from 1.5 mass % to 4.0 mass %. When the content ratio is 6.0 mass % or less, the strength developability of the cement composition can be further improved.

When the content ratio of SO₃ in the powdery cement-containing material does not fall within a desired numerical range, such as in a case where Portland cement clinker is used as the component (i) or in a case where the content ratio of SO₃ in the component (ii) is small, gypsum may be used as a material for the powdery cement-containing material in addition to the components (i), (ii), and (iv) for the purpose of adjusting the content ratio of SO₃ in the powdery cement-containing material to fall within the above-mentioned numerical ranges.

The kind of the gypsum is not particularly limited, and examples thereof include natural gypsum dihydrate, flue-gas gypsum (flue-gas desulfurization gypsum), phosphogypsum, titanogypsum, and fluorogypsum. Those gypsums may be used alone or in combination thereof. Examples of the form of the gypsum (whether the gypsum is a hydrate) include gypsum dihydrate, gypsum hemihydrate, and anhydrous gypsum. The gypsum may be formed only of one kind of form or may contain two or more forms thereof.

When the component (i) is the ground product of Portland cement clinker, the powdery cement-containing material preferably contains the gypsum in addition to the components (i), (ii), and (iv).

### [Component (vi): Others]

Another material may be blended into the powdery cement-containing material as required in addition to the components (components (i), (ii), and (iv)) described above within a range not inhibiting the object of the present invention. Examples of the other material to be blended as required include various admixtures, such as fly ash, silica fume, and blast-furnace slag fine powder, and various powdery admixtures. The powdery cement-containing material may contain an alkali metal.

The content ratio of the other material in the powdery cement-containing material is preferably 30 mass % or less, more preferably 20 mass % or less from the viewpoint of, for example, the strength developability of the powdery cement-containing material.

### [Component (B)]

The cement composition A includes an amine (iii) as the component (B).

[Component (iii): Amine]

Examples of the amine include water-soluble amines, such as chain amines (e.g., alkanolamines, alkylamines, polyamines, and hydroxylamines) and cyclic amines. Those amines may be used alone or in combination thereof.

Of those, a chain amine is preferred, and an alkanolamine is more preferred from the viewpoints of improving the strength developability and further increasing a carbon dioxide fixation amount.

The alkanolamine herein is an amine having an amino group and a hydroxyl group in a molecule thereof.

Examples of the alkanolamine include monoethanolamine, diethanolamine, triethanolamine, monoisopropanolamine, diisopropanolamine, triisopropanolamine, methyldiethanolamine, 2-amino-2-methyl-1-propanol, methyldiisopropanolamine, diethanolisopropanolamine, diisopropanolethanolamine, tetrahydroxyethyl ethylenediamine, N,N,N′,N′-tetrakis(2-hydroxypropyl)ethylenediamine, tris(2-hydroxybutyl)amine, and diglycolamine. Of those, monoethanolamine, diethanolamine, and triisopropanolamine are preferred from the viewpoints of easy availability and improvement in strength developability. Those alkanolamines may be used alone or in combination thereof.

An alkanolamine having a structure in which part of the alkanolamine is bonded to a polymer may be used as the alkanolamine.

A used alkanolamine obtained from a carbon dioxide capture device may be used as the alkanolamine. In an amine-based carbon dioxide capture device for capturing carbon dioxide from an exhaust gas of a plant or the like, a liquid containing degraded alkanolamines is typically discarded. However, in the present invention, the discarded waste liquid can be effectively utilized.

The alkanolamine is known as a grinding aid, and hence may also be used as a grinding aid.

The amount of the amine (B) is preferably from 0.001 part by mass to 5.0 parts by mass, more preferably from 0.005 part by mass to 4.0 parts by mass, still more preferably from 0.02 part by mass to 2.0 parts by mass, still more preferably from 0.05 part by mass to 1.8 parts by mass, still more preferably from 0.1 part by mass to 1.6 parts by mass, still more preferably from 0.5 part by mass to 1.4 parts by mass, particularly preferably from 0.8 part by mass to 1.2 parts by mass with respect to 100 parts by mass of the powdery cement-containing material (A) described above. When the amount is 0.001 part by mass or more, the carbon dioxide fixation amount can be further increased, and the strength developability can be further improved. When the amount is 5.0 parts by mass or less, degradation in fluidity of a hydraulic composition before hardening can be prevented.

The cement composition A is preferably powdery from the viewpoints of, for example, easy transportation, and easy production of a hydraulic composition.

[Method of producing Cement Composition A]

A method of producing the cement composition A is not particularly limited, and is, for example, a method of preparing a cement composition by mixing the materials such as the components (i) to (vi) described above.

The order of the mixing of the materials is not particularly limited, and examples thereof include: (a-1) a method involving simultaneously mixing the Portland cement or the ground product of Portland cement clinker, the ground product of the fired product containing C₂S and C₂AS, and the amine; (a-2) a method involving simultaneously pulverizing and mixing the Portland cement or the ground product of Portland cement clinker, and the fired product containing C₂S and C₂AS, and then mixing the obtained mixture and the amine; and (a-3) a method involving simultaneously pulverizing and mixing the Portland cement or the Portland cement clinker, the fired product containing C₂S and C₂AS, and the amine.

In particular, in the method (a-3) involving simultaneously pulverizing and mixing the Portland cement or Portland cement clinker, the fired product containing C₂S and C₂AS, and the amine, the amine also has an effect as a grinding aid.

When the cement composition further includes a material such as the alkaline earth metal-containing material, the material is typically mixed simultaneously with the Portland cement or the Portland cement clinker, and the fired product containing C₂S and C₂AS.

In a method of producing a hydraulic composition (described later) by kneading (mixing) the powdery cement-containing material obtained by mixing the components (i) and (ii) in advance, the component (iii), water, and aggregate, it is preferred that the component (iii) be mixed with water in advance to form an aqueous solution. In particular, when a used alkanolamine (waste liquid containing an alkanolamine) obtained from a carbon dioxide capture device is used as the component (iii), it is preferred that the component (iii) be mixed with water in advance by the above-mentioned method.

The blending amount of each material is set so that the content ratio of each material in the cement composition falls within a target numerical range. For example, the amount of the alkaline earth metal-containing material is set after the content ratio of the alkaline earth metal included in each material is determined through measurement or the like in advance so that the content ratio (in terms of oxide) of the alkaline earth metal (provided that only magnesium oxide, magnesium hydroxide, calcium oxide, and calcium hydroxide are included as the alkaline earth metal other than the alkaline earth metal included in the alkaline earth metal-containing material) in the cement composition falls within a target numerical range.

### [Cement Composition B]

Another example of the cement composition of the present invention is a cement composition (hereinafter also referred to as “cement composition B”) containing: (i) Portland cement or a ground product of Portland cement clinker; (ii) a ground product of a fired product that contains 2CaO·SiO₂ and 2CaO·Al₂O₃·SiO₂ and satisfies the above-mentioned conditions (1) and (2); and (iv) an alkaline earth metal-containing material. The content ratio of an alkaline earth metal (provided that only magnesium oxide, magnesium hydroxide, calcium oxide, and calcium hydroxide are included as the alkaline earth metal other than the alkaline earth metal included in the alkaline earth metal-containing material (in other words, alkaline earth metals included in a material other than the alkaline earth metal-containing material included in the cement composition)) in the cement composition is from 0.1 mass % to 10 mass % in terms of oxide.

The cement composition B is free of the component (iii) described above.

In the cement composition B, (i) the Portland cement or the ground product of Portland cement clinker, (ii) the ground product of the fired product that contains 2CaO·SiO₂ and 2CaO·Al₂O₃·SiO₂ and satisfies the above-mentioned conditions (1) and (2), and (iv) the alkaline earth metal-containing material may be the same materials as those used as the component (i), the component (ii), and the component (iv) in the cement composition A, respectively.

The content ratio of Portland cement or the ground product of Portland cement clinker in the cement composition B is preferably from 10 mass % to 60 mass %, more preferably from 15 mass % to 50 mass %, particularly preferably from 20 mass % to 40 mass %. When the content ratio is 10 mass % or more, strength of a hardened materials can be further increased. When the content ratio is 60 mass % or less, the content ratio of (ii) the ground product of the fired product is further increased, and thus the reduction of carbon dioxide emissions described above can be still further achieved.

In the cement composition B, the amount of the ground product of the fired product described above is preferably from 30 parts by mass to 500 parts by mass, more preferably from 65 parts by mass to 450 parts by mass, still more preferably from 100 parts by mass to 400 parts by mass, still more preferably from 150 parts by mass to 350 parts by mass, particularly preferably from 200 parts by mass to 320 parts by mass with respect to 100 parts by mass of the Portland cement or the ground product of Portland cement clinker. When the amount is 65 parts by mass or more, the amount of carbon dioxide absorbed by a hydraulic composition at an early age is further increased. When the amount is 500 parts by mass or less, degradation in strength developability of the cement composition resulting from a relatively smaller amount of the Portland cement or the ground product of Portland cement clinker is less liable to occur.

The content ratio of the ground product of the fired product in the cement composition B is preferably from 10 mass % to 90 mass %, more preferably from 30 mass % to 85 mass %, still more preferably from 40 mass % to 80 mass %, still more preferably from 50 mass % to 80 mass %, particularly preferably from 60 mass % to 80 mass %. When the content ratio is 10 mass % or more, the amount of carbon dioxide absorbed by a hydraulic composition at an early age is further increased. When the content ratio is 90 mass % or less, degradation in strength developability of the cement composition resulting from a relatively smaller amount of the Portland cement or the ground product of Portland cement clinker is less liable to occur.

The ratio of the total amount of the component (i) and the component (ii) in the cement composition B is preferably 80 mass % or more, more preferably 90 mass % or more, particularly preferably 95 mass % or more from the viewpoints of improving the strength developability of the cement composition and further increasing the amount of carbon dioxide absorbed therein.

The content ratio of an alkaline earth metal (provided that only magnesium oxide, magnesium hydroxide, calcium oxide, and calcium hydroxide are included as the alkaline earth metal other than the alkaline earth metal included in the alkaline earth metal-containing material (in other words, alkaline earth metals included in a material other than the alkaline earth metal-containing material included in the cement composition B)) in the cement composition B is from 0.1 mass % to 10 mass %, more preferably from 0.2 mass % to 8 mass %, particularly preferably from 0.5 mass % to 6 mass % in terms of oxide. When the content ratio is less than 0.1 mass %, the strength developability of the cement composition is degraded. When the content ratio is more than 10 mass %, the initial strength developability (e.g., at an age of 1 day) of the cement composition may be degraded.

When the cement composition B contains a plurality of alkaline earth metals (provided that only magnesium oxide, magnesium hydroxide, calcium oxide, and calcium hydroxide are included as the alkaline earth metal other than the alkaline earth metal included in the alkaline earth metal-containing material), the content ratio is the total of the content ratios of the plurality of alkaline earth metals.

Periclase (MgO), magnesium hydroxide (Mg(OH)₂), calcium oxide (CaO, in particular, free calcium oxide), calcium hydroxide (Ca(OH)₂), and the like may be included in the components (i) and (ii), component (v) (described later), component (vi) (described later), and the like described above. The content ratio of the alkaline earth metal includes the content ratios of the alkaline earth metals described above in addition to the content ratio of the alkaline earth metal included in the alkaline earth metal-containing material.

Alkaline earth metals (e.g., calcium) dissolved as solid solutions in silicate minerals (e.g., belite and alite), an aluminate phase, and a ferrite phase, and alkaline earth metals (alkaline earth metals other than magnesium oxide, magnesium hydroxide, calcium oxide, and calcium hydroxide), such as gypsum (CaSO₄) and calcium carbonate, included in the components (i) and (ii) and the components (v) and (vi) do not affect the effects of the present invention, or are in very small amounts and thus have hardly any impact on the effects of the present invention.

When the cement composition B contains magnesium as the alkaline earth metal, the content ratio of magnesium in the cement composition B is preferably from 1.0 mass % to 10 mass %, more preferably from 2.5 mass % to 8 mass %, particularly preferably from 4.0 mass % to 6 mass % in terms of oxide. When the content ratio is 1.0 mass % or more, the strength developability of the cement composition is further improved. When the content ratio is more than 10 mass %, the initial strength developability (e.g., at an age of 1 day) of the cement composition may be degraded.

When the cement composition B contains calcium as the alkaline earth metal, the content ratio of calcium in the cement composition B is preferably from 0.8 mass % to 10 mass %, more preferably from 1.0 mass % to 4.0 mass %, still more preferably from 1.2 mass % to 3.0 mass %, particularly preferably from 1.5 mass % to 2.0 mass % in terms of oxide. When the content ratio is 0.8 mass % or more, the strength developability of the cement composition is further improved. When the content ratio is more than 10.0 mass %, the initial strength developability (e.g., at an age of 1 day) of the cement composition may be degraded.

The content ratio of SO₃ in the cement composition B is preferably 6.0 mass % or less, more preferably from 0.5 mass % to 5.0 mass %, still more preferably from 1.0 mass % to 4.5 mass %, particularly preferably from 1.5 mass % to 4.0 mass %. When the content ratio is 6.0 mass % or less, the strength developability of the cement composition can be further improved.

When the content ratio of SO₃ in the cement composition B does not fall within a desired numerical range, such as in a case where a Portland cement clinker is used as the component (i) or a in case where the content ratio of SOS in the component (ii) is small, gypsum may be used as a material (component (v)) for the cement composition B in addition to the components (i), (ii), and (iv) for the purpose of adjusting the content ratio of SO₃ in the cement composition B to fall within the above-mentioned numerical ranges.

The gypsum (v) in the cement composition B may be the same materials as those used as the component (v) used in the cement composition A.

When the component (i) in the cement composition B is the ground product of Portland cement clinker, it is preferred that the gypsum be included in addition to the components (i), (ii), and (iv).

Another material (component (vi)) may be blended in the cement composition B as required in addition to the components (components (i), (ii), (iv), and (v)) described above within a range not inhibiting the object of the present invention.

Examples of the other material to be blended as required include various admixtures, such as fly ash, silica fume, and blast-furnace slag fine powder, and various powdery admixtures. In addition, the cement composition B may contain an alkali metal in addition to the alkaline earth metal.

The content ratio of the other material in the cement composition B is preferably 30 mass % or less, more preferably 20 mass % or less from the viewpoint of, for example, the strength developability of the cement composition.

The cement composition B is preferably powdery from the viewpoints of, for example, easy transportation, and easy production of a hydraulic composition.

### [Method of Producing Cement Composition B]

A method of producing the cement composition B is not particularly limited, and is, for example, a method of preparing a cement composition by mixing materials such as the components (i), (ii), and (iv) to (vi) described above.

The order of the mixing of the materials is not particularly limited, and examples thereof include: (i) a method involving simultaneously mixing the Portland cement or the ground product of Portland cement clinker, the ground product of the fired product containing C₂S and C₂AS, and the powdery alkaline earth metal-containing material; (ii) a method involving simultaneously pulverizing and mixing Portland cement or a Portland cement clinker, the fired product containing C₂S and C₂AS, and a massive alkaline earth metal-containing material; and (iii) a method involving simultaneously pulverizing and mixing Portland cement or Portland cement clinker, and the fired product containing C₂S and C₂AS, and then mixing the obtained mixture and the powdery alkaline earth metal-containing material.

When the Portland cement or the Portland cement clinker, and the fired product containing C₂S and C₂AS are ground, a grinding aid may be used.

The blending amount of each material is set so that the content ratio of each material in the cement composition falls within a target numerical range. For example, the amount of the alkaline earth metal-containing material is set after the content ratio of the alkaline earth metal included in each material is determined through measurement or the like in advance so that the content ratio (in terms of oxide) of the alkaline earth metal (provided that only magnesium oxide, magnesium hydroxide, calcium oxide, and calcium hydroxide are included as the alkaline earth metal other than the alkaline earth metal included in the alkaline earth metal-containing material) in the cement composition falls within a target numerical range.

### [Hydraulic Composition]

The cement composition A or B described above can be hardened when the cement composition contains water.

An example of the hydraulic composition of the present invention is a hydraulic composition (hereinafter also referred to as “hydraulic composition A”) including the cement composition A described above, water, and aggregate, in which the amount of the water is from 25 parts by mass to 70 parts by mass with respect to 100 parts by mass of the powdery cement-containing material.

Another example of the hydraulic composition of the present invention is a hydraulic composition (hereinafter also referred to as “hydraulic composition B”) including the cement composition B described above, water, and aggregate, in which the amount of the water is from 25 parts by mass to 70 parts by mass with respect to 100 parts by mass of the cement composition.

The term “hydraulic composition” herein encompasses a form having fluidity before hardening and a form after hardening.

The water is not particularly limited, and examples thereof include tap water and recovered water specified in “JIS A 5308:2019 (Ready-mixed concrete).”

In the hydraulic composition A, the amount of the water is from 25 parts by mass to 70 parts by mass, preferably from 30 parts by mass to 65 parts by mass, more preferably from 40 parts by mass to 60 parts by mass, particularly preferably from 45 parts by mass to 55 parts by mass with respect to 100 parts by mass of the powdery cement-containing material. When the amount is less than 25 parts by mass, the fluidity of the hydraulic composition before hardening is reduced. When the amount is more than 70 parts by mass, the strength of a hardened materials of the hydraulic composition is reduced.

In the hydraulic composition B, the amount of the water is from 25 parts by mass to 70 parts by mass, preferably from 30 parts by mass to 65 parts by mass, more preferably from 40 parts by mass to 60 parts by mass, particularly preferably from 45 parts by mass to 55 parts by mass with respect to 100 parts by mass of the cement composition B. When the amount is less than 25 parts by mass, the fluidity of the hydraulic composition before hardening is reduced. When the amount is more than 70 parts by mass, the strength of a hardened materials of the hydraulic composition is reduced.

The aggregate is, for example, fine aggregate alone, or a combination of the fine aggregate and coarse aggregate. Any of natural aggregate, artificial aggregate, and recycled aggregate may be used.

The fine aggregate is not particularly limited, and examples thereof include river sand, mountain sand, land sand, sea sand, crushed sand, silica sand, limestone fine aggregate, slag fine aggregate, lightweight fine aggregate, clinker fine aggregate, glass fine aggregate, and CCU fine aggregate (fine aggregate obtained by fixing carbon dioxide to one or more kinds selected from recycled aggregate, waste concrete, blast furnace slag, and steelmaking slag). Those fine aggregates may be used alone or in combination thereof.

The coarse aggregate is not particularly limited, and examples thereof include river gravel, mountain gravel, land gravel, sea gravel, crushed stone, limestone coarse aggregate, slag coarse aggregate, lightweight coarse aggregate, clinker coarse aggregate, glass coarse aggregate, and CCU coarse aggregate (coarse aggregate obtained by fixing carbon dioxide to one or more kinds selected from recycled aggregate, waste concrete, blast furnace slag, and steelmaking slag). Those coarse aggregates may be used alone or in combination thereof.

When the hydraulic composition includes the coarse aggregate, a fine aggregate ratio (a volume ratio of (fine aggregate/(fine aggregate+coarse aggregate) expressed in percentage) is preferably from 5% to 70%, more preferably from 10% to 60%, particularly preferably from 20% to 50%. When the fine aggregate ratio falls within the above-mentioned ranges, the workability and ease of molding of the hydraulic composition before hardening are improved.

The content (when the fine aggregate and the coarse aggregate are used in combination, the total amount thereof) of the aggregate in the hydraulic composition A is preferably from 200 parts by mass to 750 parts by mass, more preferably from 300 parts by mass to 650 parts by mass with respect to 100 parts by mass of the powdery cement-containing material.

The content (when the fine aggregate and the coarse aggregate are used in combination, the total amount thereof) of the aggregate in the hydraulic composition B is preferably from 200 parts by mass to 750 parts by mass, more preferably from 300 parts by mass to 650 parts by mass with respect to 100 parts by mass of the cement composition B.

When the contents fall within the above-mentioned numerical ranges, the strength of a hardened materials of the hydraulic composition is further increased, and a shrinkage ratio of the hardened materials is further reduced.

The hydraulic composition may include various admixtures, such as a cement dispersant (a water-reducing agent, an AE water-reducing agent, a high-performance water-reducing agent, or a high-performance AE water-reducing agent), an AE agent, a defoaming agent, and a shrinkage-reducing agent, organic fibers, glass fibers, and the like within a range not inhibiting the object of the present invention as required.

When the hydraulic composition of the present invention is a carbonated hardened materials obtained through carbonation (in particular, a hardened materials obtained by performing carbonation curing), the strength of the hydraulic composition can be further increased.

The carbonated hardened materials may be obtained by subjecting the hydraulic composition to carbonation curing, for example. Through the carbonation curing, carbon dioxide is fixed to the hydraulic composition, and the structure of the hydraulic composition is densified. Thus, the strength of the hydraulic composition can be further increased.

A method for the carbonation curing is not particularly limited, and examples thereof include a method involving performing carbonation curing by exposing the hydraulic composition to carbon dioxide, and a method involving blowing carbon dioxide into the hydraulic composition (in this case, a larger amount of carbon dioxide can be absorbed) during kneading of the hydraulic composition.

The carbonation (other than carbonation curing) of the hydraulic composition includes a mode in which a form of a concrete product, a concrete structure, a concrete pavement, or the like absorbs carbon dioxide in air over a long period of time, resulting in natural carbonation.

The carbon dioxide fixation amount per ton of the cement composition is preferably from 80 kg/ton to 400 kg/ton, more preferably from 100 kg/ton to 350 kg/ton, still more preferably from 150 kg/ton to 330 kg/ton, still more preferably from 200 kg/ton to 315 kg/ton, particularly preferably from 250 kg/ton to 300 kg/ton. When the fixation amount is 80 kg/ton or more, the total amount of carbon dioxide to be emitted can be further reduced. When the fixation amount is 400 kg/ton or less, producibility can be further improved.

[Method of producing Hydraulic Composition]

An example of a method of performing carbonation curing to produce a carbonated hardened materials of the hydraulic composition is a method including: a kneaded product preparing step of preparing a kneaded product by using materials for forming a cement composition, water, and aggregate, the kneaded product being the hydraulic composition; a placing step of placing the kneaded product into formwork; a removing step of removing a hardened materials of the kneaded product from the formwork after the kneaded product in the formwork is hardened; and a carbonation curing step of subjecting the hardened materials of the hydraulic composition removed from the formwork to carbonation curing to provide a carbonated hardened materials of the hydraulic composition.

Each step is described in detail below.

### [Kneaded Product Preparing Step]

The kneaded product preparing step is a step of preparing a kneaded product (mixture) by using the materials for forming the cement composition, the water, and the aggregate, the kneaded product being the hydraulic composition.

Regarding the hydraulic composition A, a method of preparing a kneaded product by using the materials for forming the hydraulic composition A, the water, and the aggregate, the kneaded product being the hydraulic composition A, is not particularly limited, and examples thereof include: (a-1) a method involving simultaneously kneading (mixing) the cement composition A prepared in advance, the water, and the aggregate; and (a-2) a method involving simultaneously kneading (mixing) the powdery cement-containing material (A) formed by mixing the components (i) and (ii) for forming the component (A) in advance, the component (B), the water, and the aggregate.

Regarding the hydraulic composition B, a method of preparing a kneaded product by using the materials for forming the hydraulic composition B, the water, and the aggregate, the kneaded product being the hydraulic composition B, is not particularly limited, and examples thereof include: (b-1) a method involving simultaneously mixing the cement composition B prepared in advance, the water, and the aggregate; and (b-2) a method involving simultaneously mixing a mixture of the components (i) and (ii) mixed in advance, the component (iv), the water, the aggregate.

A method of kneading the materials is not particularly limited. A device used for the kneading is also not particularly limited, and a commonly used mixer, such as Omni mixer, a pan-type mixer, a twin-shaft mixer, or a tilting-drum mixer, may be used, for example.

### [Placing Step]

The placing step is a step of placing the kneaded product obtained in the previous step into formwork.

A placing method is not particularly limited, and a commonly used method such as pouring may be used.

A curing method performed after the kneaded product is placed into the formwork and until the kneaded product is removed therefrom is not particularly limited, and a general curing method, such as air curing, moist curing, water curing, sealed curing, or steam curing, may be applied, for example.

### [Removing Step]

The removing step is a step of removing a hardened materials, which is obtained by hardening the kneaded product, of the hydraulic composition from the formwork after the kneaded product in the formwork is hardened.

### [Carbonation Curing Step]

The carbonation curing step is a step of subjecting the hardened materials of the hydraulic composition removed from the formwork to carbonation curing to provide a carbonated hardened materials obtained by carbonating the hardened materials of the hydraulic composition.

The concentration of a carbon dioxide gas in the carbonation curing is preferably 1 vola or more, more preferably 10 vol % or more, still more preferably 50 vol % or more, particularly preferably 60 vol % or more from the viewpoint of further increasing absorption of carbon dioxide during the carbonation curing. From the viewpoint of, for example, reducing the cost for curing equipment and the like, the concentration of the carbon dioxide gas is preferably 95 vol % or less, more preferably 85 vol, or less, still more preferably 80 vol, or less.

The temperature during the carbonation curing is preferably from 5° C. to 100° C., more preferably from 10° C. to 90° C., still more preferably from 15° C. to 80° C., still more preferably from 20° C. to 75° C., still more preferably from 25° C. to 70° C., still more preferably from 30° C. to 65° C., still more preferably from 30° C. to 50° C., particularly preferably from 30° C. to 40° C. When the temperature is 5° C. or more, the efficiency of carbonation is further improved, and the strength of the hardened materials is further increased. When the temperature is 100° C. or less, the energy cost for the carbonation curing can be further reduced.

The relative humidity during the carbonation curing is preferably from 20% to 90%, more preferably from 30% to 80%, particularly preferably from 40% to 70%. When the relative humidity is 20% or more, the efficiency of carbonation is further improved, and the strength of the hardened materials is further increased. When the relative humidity is 90% or less, the cost for curing equipment and the like can be further reduced.

### EXAMPLES

The present invention is specifically described below by way of Examples. However, the present invention is not limited to these Examples.

[A. Production of Fired Product as Component (ii)]

Sewage sludge, construction-generated soil, limestone, and clay were used as raw materials, and the raw materials were mixed so that a target chemical composition range including the chemical composition (actually measured values in Examples) shown in Table 1 was achieved. Thus, a raw material for firing was prepared. The raw material for firing was then fired at 1,370° C. with a rotary kiln to provide a fired product. Waste oil and waste plastics were used as a fuel in the firing in addition to heavy oil.

Next, the fired product was ground, and then a powder X-ray diffraction (XRD) pattern of the resultant ground product was acquired with an X-ray diffractometer (manufactured by Bruker Japan K.K., product name: “D8 ADVANCE A-25”). Measurement conditions for powder X-ray diffraction were as follows: target: CuKα; tube settings: 40 kV-40 mA; scan range: 2θ=5° to 65°; step width: 0.023°/step; and measurement time: 0.13 second/step. The resultant powder XRD pattern was qualitatively analyzed with analysis software (manufactured by Bruker Japan K.K., product name: “DIFFRAC.EVA”), and peaks of C₂S (β-C₂S), C₂AS, C₃A, and CA were recognized. Meanwhile, no peak of MgO (periclase) was recognized.

The mineral composition of the ground product was measured by fitting, into the actually measured profile obtained from the powder XRD results, each of the theoretical profiles of the minerals C₂S (β-C₂S), C₂AS, C₃A, and CA by the Rietveld method with the above-mentioned analysis software (manufactured by Bruker Japan K.K., product name: “DIFFRAC.EVA”). The results are shown in Table 2.

The content ratio of f.CaO in the fired product was measured in conformity with “JCAS I-01-1997 (Determination method for free calcium oxide)” and was 0.3 mass %.

The fired product was free of Mg(OH)₂ and Ca(OH)₂.

The Blaine specific surface area of the ground product of the fired product was 3,310 cm²/g.

TABLE 1

| SiO₂ | Al₂O₃ | Fe₂O₃ | CaO | MgO | SO₃ | Na₂O | K₂O | TiO₂ | P₂O₅ | MnO | Cl | Cr | Pb |
|---|---|---|---|---|---|---|---|---|---|---|---|---|---|
| (mass %) | | | | | | | | | | | | (ppm) | |
| 31.3 | 6.4 | 3.9 | 55.3 | 1.2 | 0.1 | 0.3 | 0.7 | 0.3 | 1.2 | 0.04 | <0.001 | 125 | 4 |

TABLE 2

| C₂S¹⁾ | | C₂AS²⁾ | | C₃A³⁾ | | CA⁴⁾ | |
|---|---|---|---|---|---|---|---|
| | (part(s) | | (part(s) | | (part(s) | | (part(s) |
| (mass %) | by mass) | (mass %) | by mass) | (mass %) | by mass) | (mass %) | by mass) |
| 68.8 | 100.0 | 29.8 | 43.3 | 0.9 | 1.3 | 0.5 | 0.7 |

¹⁾C₂S: 2CaO•SiO₂
²⁾C₂AS: 2CaO•Al₂O₃•SiO₂
³⁾C₃A: 3CaO•Al₂O₃
⁴⁾CA: CaO•Al₂O₃

### [B. Preparation of Hydraulic Composition]

### [Used Materials]

(1) Cement: ordinary Portland cement (Blaine specific surface area: 3,290 cm²/g), manufactured by TAIHEIYO CEMENT CORPORATION, cement having the chemical composition shown in Table 3 and the mineral composition shown in Table 4

The chemical composition of the cement was measured in conformity with “JIS R 5204:2019 (Chemical analysis method of cement by X-ray fluorescence).” No peak of MgO (periclase) was recognized in X-ray diffraction. The mineral composition of the cement was measured in the same manner as for the ground product of the fired product described above except that the mineral settings in the analysis software were changed to the kinds of minerals shown in Table 4. The content ratio of f.CaO in the cement measured in conformity with “JCAS I-01-1997 (Determination method for free calcium oxide)” was 0.2 mass %. The cement was free of Mg(OH), and Ca(OH)₂.
(2) Fired product: the fired product described above
(3) Gypsum: flue-gas gypsum dihydrate
(4) Amine A: monoethanolamine (2-aminoethanol)
(5) Amine B: diethanolamine (2,2′-iminodiethanol)
(6) Amine C: aqueous solution of triisopropanolamine (content ratio of triisopropanolamine: 85 mass %)
(7) Amine D: 2-amino-2-methyl-1-propanol
(8) MgO: periclase (industrial reagent, MgO content ratio: 95.0 mass %, or more)
(9) MgSO₄·7H₂O: reagent
(10) CaO: hard-burned quicklime (industrial reagent, CaO content ratio: 93.0 mass % or more)
(11) fresh concrete sludge: fresh concrete sludge subjected to drying at 105° C. as pretreatment and then pulverization, the fresh concrete sludge having a BET surface area of 14.71 m²/g, an average particle diameter (frequency-based) of 46.9 μm, a 50% cumulative volume particle diameter (D50) of 20.4 μm, the chemical composition (measured in conformity with “JIS R 5204:2019 (Chemical analysis method of cement by X-ray fluorescence)”) shown in Table 5, and a calcium hydroxide amount of 15.8 mass %
(12) Fine aggregate: standard sand from Japan Cement Association

TABLE 3

| ig. loss | SiO₂ | Al₂O₃ | Fe₂O₃ | CaO | MgO | SO₃ | Na₂O | K₂O | TiO₂ | P₂O₅ | MnO | Cl | Cr | Pb |
|---|---|---|---|---|---|---|---|---|---|---|---|---|---|---|
| (mass %) | | | | | | | | | | | | | (ppm) | |
| 3.2 | 21.4 | 5.4 | 3.0 | 62.0 | 1.0 | 2.1 | 0.3 | 0.4 | 0.3 | 0.7 | 0.07 | 0 | 219 | 89 |

TABLE 4

| | | | | | | |
|---|---|---|---|---|---|---|
| | | | | Gypsum | Gypsum | |
| C₃S¹⁾ | C₂S²⁾ | C₄AF³⁾ | C₃A⁴⁾ | dihydrate | hemihydrate | CaCO₃ |

(mass %)

| | | | | | | |
|---|---|---|---|---|---|---|
| 56.7 | 19.5 | 9.9 | 7.3 | 0.9 | 1.7 | 4.0 |

¹⁾C₃S: 3CaO•SiO₂
²⁾C₂S: 2CaO•SiO₂
³⁾C₄AF: 4CaO•Al₂O₃•Fe₂O₃
⁴⁾C₃A: 3CaO•Al₂O₃

TABLE 5

| | | | | | | | | | | |
|---|---|---|---|---|---|---|---|---|---|---|
| ig. loss | SiO₂ | Al₂O₃ | Fe₂O₃ | CaO | MgO | SO₃ | Na₂O | K₂O | TiO₂ | P₂O₅ |

(mass %)

| | | | | | | | | | | |
|---|---|---|---|---|---|---|---|---|---|---|
| 21.8 | 19.5 | 5.1 | 2.6 | 46.7 | 11.4 | 1.5 | 0.2 | 0.2 | 0.3 | 0.4 |

### Examples 1 to 3

The fired product and flue-gas gypsum dihydrate were mixed in amounts to achieve a mass ratio of 95.67:4.33 and ground to provide a mixture of a ground product of the fired product and the flue-gas gypsum dihydrate.

The mixture and ordinary Portland cement were mixed in amounts to achieve a mass ratio of 75:25 (mixture:ordinary Portland cement) to provide a powdery cement-containing material. The chemical composition (actually measured values) and mineral composition (calculated values) of the powdery cement-containing material are shown in Table 6 and Table 7, respectively.

The chemical composition of the powdery cement-containing material was measured in conformity with “JIS R 5204:2019 (Chemical analysis method of cement by X-ray fluorescence).” The mineral composition was measured in the same manner as for the ground product of the fired product. The Blaine specific surface area of the powdery cement-containing material was 3,300 cm²/g.

A sample was produced in conformity with “JIS R 5201:2015 (Physical testing methods for cement)” by using the obtained powdery cement-containing material, an amine of the kind shown in Table 8, fine aggregate, and water in amounts shown in Table 8 (“Water/powdery cement-containing material” in Table 8 indicates the mass ratio of water to the powdery cement-containing material), removed from a mold after a lapse of 1 day, and subjected to carbonation curing in a curing tank at a temperature of 65° C., a relative humidity of 60%, and a carbon dioxide concentration of 80 vol %. While the carbonation curing was performed, the compressive strength and bending strength of the sample (hardened materials of the hydraulic composition) at the time of an age of 7 days (excluding 1 day required after the production of the sample until the sample was removed from the mold) were measured in conformity with “JIS R 5201:2015 (Physical testing methods for cement).”

A sample was produced in the same manner as that for the measurement of compressive strength and bending strength described above, removed from a mold, and then subjected to carbonation curing in a curing tank at a temperature of 65° C., a relative humidity of 60%, and a carbon dioxide concentration of 20 vol %. The sample at the time of an age of each of 3, 7, and 14 days was ground. After that, a carbon content in the sample was measured with a carbon/sulfur analyzer, and a carbon dioxide content (A) in the sample was determined by converting the obtained measurement value to CO₂. Next, a carbon dioxide content (B) in the sample before carbonation curing was determined on the basis of the carbon content in the sample (hardened materials of the hydraulic composition) at each age measured with the carbon/sulfur analyzer and the formulation of the hydraulic composition, and the amount of carbon dioxide fixed in the sample was calculated from the difference (A-B) between the carbon dioxide content before carbonation curing and the carbon dioxide content after the curing.

The carbon dioxide fixation amount (kg/ton) was calculated by dividing the carbon dioxide fixation amount in the sample by the amount of cement used for the sample.

After carbonation curing was performed up to an age of 3 days, the sample was taken out from the curing tank, and further cured for 4 days in a constant temperature and humidity chamber at a temperature of 20° C. and a relative humidity of 60%, and a carbon dioxide fixation amount in the sample (referred to as “3 Days+4 Days” in Table 9) was similarly measured.

### Comparative Example 1

The compressive strength, bending strength, and the like of the hydraulic composition at an age of 7 days were measured in the same manner as in Example 1 except that no amine was used.

The results are shown in Table 9.

TABLE 6

| ig. loss | SiO₂ | Al₂O₃ | Fe₂O₃ | CaO | MgO | SO₃ | Na₂O | K₂O | TiO₂ | P₂O₅ | MnO | Cl | Cr | Pb |
|---|---|---|---|---|---|---|---|---|---|---|---|---|---|---|
| (mass %) | | | | | | | | | | | | | (ppm) | |
| 1.5 | 27.7 | 5.9 | 3.6 | 56.0 | 1.1 | 2.0 | 0.3 | 0.6 | 0.3 | 1.0 | 0.04 | 0.001 | 144 | 25 |

TABLE 7

| | | | | | | | | |
|---|---|---|---|---|---|---|---|---|
| | | | | | | Gypsum | Gypsum | |
| C₃S¹⁾ | C₂S²⁾ | C₄AF³⁾ | C₃A⁴⁾ | C₂AS⁵⁾ | CA⁶⁾ | dihydrate | hemihydrate | CaCO₃ |

(mass %)

| | | | | | | | | |
|---|---|---|---|---|---|---|---|---|
| 13.9 | 54.1 | 2.4 | 2.4 | 21.4 | 0.4 | 3.5 | 0.4 | 1.5 |

¹⁾C₃S: 3CaO•SiO₂
²⁾C₂S: 2CaO•SiO₂
³⁾C₄AF: 4CaO•Al₂O₃•Fe₂O₃
⁴⁾C₃A: 3CaO•Al₂O₃
⁵⁾CA: CaO•Al₂O₃

TABLE 8

| | Water/ | Powdery | | | | |
|---|---|---|---|---|---|---|
| | powdery | cement- | | | | |
| | cement- | containing | | Fine | Amine | |
| | containing | material | Water | aggregate | | Part(s) |
| | material | Part(s) by mass | | | Kind | by mass¹⁾ |
| Example 1 | 0.5 | 450 | 225 | 1,350 | A | 1.0 |
| Example 2 | 0.5 | 450 | 225 | 1,350 | B | 1.0 |
| Example 3 | 0.5 | 450 | 225 | 1,350 | C | 1.18 (1.0) |
| Comparative | 0.5 | 450 | 225 | 1,350 | — | — |
| Example 1 | | | | | | |

¹⁾Amount (part(s) by mass) with respect to 100 parts by mass of powdery cement-containing material, the parenthesized numerical value being a numerical value in terms of amine

TABLE 9

| | Compressive | Bending | Carbon dioxide fixation | | | |
|---|---|---|---|---|---|---|
| | strength | strength | amount (kg/ton) | | | |
| | (N/mm²) | (N/mm²) | 3 | 7 | 14 | 3 Days + |
| | 7 Days | 7 Days | Days | Days | Days | 4 Days |
| Example 1 | 68.2 | 10.4 | 235 | 240 | 247 | 238 |
| Example 2 | 55.9 | 12.2 | 236 | 239 | 239 | 236 |
| Example 3 | 63.1 | 11.5 | 232 | 237 | 243 | 237 |
| Comparative | 55.6 | 10.4 | 227 | 231 | 234 | 233 |
| Example 1 | | | | | | |

From Table 9, it is found that the compressive strengths (55.9 N/mm² to 68.2 N/mm²) in Examples 1 to 3 are larger than the compressive strength (55.6 N/mm²) in Comparative Example 1.

It is found that the bending strengths (10.4 N/mm² to 12.2 N/mm²) at an age of 7 days in Examples 1 to 3 are equal to or larger than the bending strength (10.4 N/mm²) at an age of 7 days in Comparative Example 1.

It is found that the carbon dioxide fixation amounts (age of 3 days: 232 kg/ton to 236 kg/ton; age of 7 days: 237 kg/ton to 240 kg/ton; age of 14 days: 239 kg/ton to 247 kg/ton; age of 3 days+4 days: 236 kg/ton to 238 kg/ton) in Examples 1 to 3 are larger than the carbon dioxide fixation amounts (age of 3 days: 227 kg/ton; age of 7 days: 231 kg/ton; age of 14 days: 234 kg/ton; age of 3 days+4 days: 233 kg/ton) in Comparative Example 1.

### Examples 4 to 8

The powdery cement-containing material prepared in Example 1 and an alkaline earth metal-containing material of the kind shown in Table 10 were mixed in the blending amounts shown in Table 10 to provide a cement composition. In Table 10, the “alkaline earth metal content ratio” is an alkaline earth metal content ratio (in terms of oxide) in the cement composition. In Table 10, the “f.CaO-derived” means f.CaO included in the cement composition. A sample was produced in conformity with “JIS R 5201:2015 (Physical testing methods for cement)” by using the obtained cement composition (referred to as “composition” in Table 10), fine aggregate, and water in the respective amounts (“water/composition” in Tables 10, 12, and 14 represents the mass ratio of water to the cement composition) shown in Table 10, removed from a mold, and then subjected to carbonation curing in a curing tank at a temperature of 30° C., a relative humidity of 60%, and a carbon dioxide concentration of 80 vol %. While the carbonation curing was performed, the compressive strength and bending strength of the sample (hardened materials of the hydraulic composition) at the time of an age of each of 3 days and 7 days were measured in conformity with “JIS R 5201:2015 (Physical testing methods for cement).”

With regard to the sample at the time of an age of each of 1 day, 3 days, and 7 days having been subjected to carbonation curing in the same manner as the sample used for bending strength measurement, a 1 phenolphthalein ethanol solution was sprayed onto a fractured cross-section of the sample after a bending test, neutralization depths (areas colored by the spray of the 1% phenolphthalein ethanol solution) from sample side surfaces (four sides) were measured with a caliper, and the average value thereof was taken as a neutralization depth (carbonation depth) value. In Table 11, “20.0 mm” indicates complete neutralization.

### Comparative Example 2

The compressive strength and bending strength of the hydraulic composition at the time of an age of each of 3 days and 7 days were measured in the same manner as in Example 4 except that no alkaline earth metal-containing material was used.

The results are shown in Table 11.

TABLE 10

| | | Powdery | Alkaline earth | | | | | | | |
|---|---|---|---|---|---|---|---|---|---|---|
| | | cement- | metal-containing | | Alkaline earth metal content | | | | | |
| | | containing | material | | ratio | | | | | Fine |
| | | material | | (part(s) | (in terms of oxide (mass %)) | | | | Water | aggregate |
| | Water/ | (part(s) by | | by | | | f•CaO- | | (part(s) | (part(s) |
| | composition | mass) | Kind | mass) | Ma | Ca | derived | Total | by mass) | by mass) |
| Example 4 | 0.5 | 442.5 | MgO | 7.5 | 1.7 | — | 0.3 | 2.0 | 225 | 1,350 |
| Example 5 | 0.5 | 435.0 | | 15.0 | 3.3 | — | 0.3 | 3.6 | 225 | 1,350 |
| Example 6 | 0.5 | 427.5 | | 22.5 | 5.0 | — | 0.3 | 5.3 | 225 | 1,350 |
| Example 7 | 0.5 | 442.5 | CaO | 7.5 | — | 1.7 | 0.3 | 2.0 | 225 | 1,350 |
| Example 8 | 0.5 | 442.5 | Sludge | 7.5 | — | 0.2 | 0.3 | 0.5 | 225 | 1,350 |
| Comparative | 0.5 | 450.0 | — | — | — | — | 0.3 | 0.3 | 225 | 1,350 |
| Example 2 | | | | | | | | | | |

TABLE 11

| | Compressive | | Bending | | | | |
|---|---|---|---|---|---|---|---|
| | strength | | strength | | Neutralization | | |
| | (N/mm²) | | (N/mm²) | | depth (mm) | | |
| | 3 Days | 7 Days | 3 Days | 7 Days | 1 Day | 3 Days | 7 Days |
| Example 4 | 53.9 | 62.6 | 10.9 | 13.2 | 20.0 | 20.0 | 20.0 |
| Example 5 | 57.0 | 66.3 | 12.5 | 13.7 | 10.5 | 20.0 | 20.0 |
| Example 6 | 58.0 | 72.7 | 11.8 | 14.8 | 8.2 | 20.0 | 20.0 |
| Example 7 | 49.8 | 59.4 | 9.4 | 12.1 | 13.2 | 20.0 | 20.0 |
| Example 8 | 48.9 | 58.3 | 10.1 | 12.4 | 8.2 | 20.0 | 20.0 |
| Comparative | 45.1 | 52.8 | 9.8 | 11.7 | 20.0 | 20.0 | 20.0 |
| Example 2 | | | | | | | |

From Table 11, it is found that the compressive strengths (age of 3 days: 48.9 N/mm² to 58.0 N/mm²; age of 7 days: 58.3 N/mm² to 72.7 N/mm²) in Examples 4 to 8 are larger than the compressive strengths (age of 3 days: 45.1 N/mm²; age of 7 days: 52.8 N/mm²) in Comparative Example 2.

It is found that the bending strengths (10.1 N/mm² to 12.5 N/mm²) at an age of 3 days in Examples 4 to 6 and 8 are larger than the bending strength (9.8 N/mm²) at an age of 3 days in Comparative Example 2.

It is found that the bending strengths (12.1 N/mm² to 14.8 N/mm²) at an age of 7 days in Examples 4 to 8 are larger than the bending strength (11.7 N/mm²) at an age of 7 days in Comparative Example 2.

From the neutralization depths in Examples 4 to 8, it is found that carbonation of the sample has reached the inside thereof at an age of 3 days.

### Examples 9 to 12 and 14

The mixture (corresponding to the powdery cement-containing material in Example 1, referred to as “Powder raw material” in Table 12) of the mixture of the ground product of the fired product and flue-gas gypsum dihydrate, and ordinary Portland cement prepared in Example 1, and an amine of the kind shown in Table 12 and in the blending amount shown therein were mixed to provide a cement composition.

A sample was produced in conformity with “JIS R 5201:2015 (Physical testing methods for cement)” by using the obtained cement composition (referred to as “composition” in Table 12), fine aggregate, and water in the respective amounts shown in Table 12 (“water/composition” in Tables 12 represents the mass ratio of water to the cement composition), removed from a mold, and then subjected to carbonation curing in a curing tank at a temperature of 30° C., a relative humidity of 60%, and a carbon dioxide concentration of 80 vol %. While the carbonation curing was performed, the compressive strength of the sample (hardened materials of the hydraulic composition) at an age of 7 days was measured in conformity with “JIS R 5201:2015 (Physical testing methods for cement).”

A sample was produced in the same manner as that for the measurement of compressive strength described above, removed from a mold, and then subjected to carbonation curing in a curing tank at a temperature of 30° C., a relative humidity of 60%, and a carbon dioxide concentration of 20 vol %. The carbon dioxide fixation amount (kg/ton) of the sample at the time of an age of each of 3 days and 7 days was calculated in the same manner as in Example 1.

In Table 13, the symbol “-” indicates that measurement was not conducted.

### Example 13

The mixture of the mixture of the ground product of the fired product and flue-gas gypsum dihydrate, and ordinary Portland cement prepared in Example 1 and an alkaline earth metal-containing material in the amount shown in Table 12 were mixed to provide a powdery cement-containing material. The obtained powdery cement-containing material, and an amine of the kind shown in Table 12 and in the blending amount shown therein were mixed to provide a cement composition. In Table 12, “f.CaO-derived” means f.CaO included in the powdery cement-containing material.

A sample was produced in the same manner as in Example 9 by using the obtained cement composition, and the compressive strength of the sample at an age of 7 days was measured in the same manner as in Example 9.

The bending strength of the sample at the time of an age of each of 3 days and 7 days was measured in conformity with “JIS R 5201:2015 (Physical testing methods for cement).”

The neutralization depths from sample side surfaces (four sides) of the sample at the time of an age of each of 3 days and 7 days having been subjected to carbonation curing in the same manner as the sample used for bending strength measurement were measured, and the average value thereof was taken as a neutralization depth (carbonation depth) value, in the same manner as in Example 4. In Table 13, “20.0 mm” indicates complete neutralization.

The results are shown in Table 13.

TABLE 12

| | | Powdery cement-containing material | | | | | | | | | |
|---|---|---|---|---|---|---|---|---|---|---|---|
| | | | | | Alkaline earth metal | | | | | | |
| | | Powder | Alkaline earth | | content ratio | | | | | | |
| | | raw | metal-containing | | (in terms of oxide | | | | | | Fine |
| | | material | material | | (mass %)) | | | Amine | | Water | aggregate |
| | Water/ | (part(s) | | (part(s) | | f•CaO- | | | (part(s) | (part(s) | (part(s) |
| | composition | by mass) | Kind | by mass) | Mg | derived | Total | Kind | by mass¹⁾) | by mass) | by mass) |
| Example 9 | 0.5 | 450.0 | — | — | — | — | — | C | 0.01 | 225 | 1,350 |
| Example 10 | 0.5 | 450.0 | — | — | — | — | — | C | 0.59 | 225 | 1,350 |
| Example 11 | 0.5 | 450.0 | — | — | — | — | — | C | 1.18 | 225 | 1,350 |
| Example 12 | 0.5 | 450.0 | — | — | — | — | — | C | 2.95 | 225 | 1,350 |
| Example 13 | 0.5 | 427.5 | MgO | 22.5 | 5.0 | 0.3 | 5.3 | C | 1.18 | 225 | 1,350 |
| Example 14 | 0.5 | 450.0 | — | — | — | — | — | D | 0.50 | 225 | 1,350 |

¹⁾Amount (part(s) by mass) with respect to 100 parts by mass of powdery cement-containing material

TABLE 13

| | Compressive | | | | | Carbon dioxide | |
|---|---|---|---|---|---|---|---|
| | strength at | Bending strength | | Neutralization | | fixation amount | |
| | 7 days | (N/mm²) | | depth (mm) | | (kg/ton) | |
| | (N/mm²) | 3 Days | 7 Days | 3 Days | 7 Days | 3 Days | 7 Days |
| Example | 60.6 | — | — | — | — | 288 | 292 |
| 9 | | | | | | | |
| Example | 65.5 | — | — | — | — | 293 | 315 |
| 10 | | | | | | | |
| Example | 68.2 | — | — | — | — | 291 | 308 |
| 11 | | | | | | | |
| Example | 61.5 | — | — | — | — | 219 | 302 |
| 12 | | | | | | | |
| Example | 74.8 | 11.8 | 16.6 | 13.2 | 20.0 | — | — |
| 13 | | | | | | | |
| Example | 66.3 | — | — | — | — | 298 | 300 |
| 14 | | | | | | | |

From Table 9 and Table 13, it is found that the carbon dioxide fixation amounts (292 kg/ton to 315 kg/ton) at an age of 7 days in Examples 9 to 12 and 14 are larger than the carbon dioxide fixation amounts (237 kg/ton to 240 kg/ton) at an age of 7 days in Examples 1 to 3 (in which carbonation curing was performed in the curing tank at a temperature of 65° C., a relative humidity of 60%, and a carbon dioxide concentration of 20 vol %).

From Table 11 and Table 13, it is found that the compressive strengths (60.6 N/mm² to 74.8 N/mm²) at an age of 7 days in Examples 9 to 14 are larger than the compressive strength (age of 7 days: 52.8 N/mm²) in Comparative Example 2 (in which none of the amine and the alkaline earth metal-containing material was used, and the curing conditions were the same as those in Examples 9 to 14).

In particular, it is found that the compressive strength (74.8 N/mm²) at an age of 7 days in Example 13 (in which the amine and the alkaline earth metal-containing material were used) is the largest.

It is found that the bending strengths (age of 3 days: 11.8 N/mm²; age of 7 days: 16.6 N/mm²) in Example 13 in particular are larger than the bending strengths (age of 3 days: 9.8 N/mm²; age of 7 days: 11.7 N/mm²) in Comparative Example 2.

From the neutralization depth in Example 13, it is found that carbonation of the sample has reached the inside thereof at the age of 7 days.

### Examples 15 and 16

The mixture (corresponding to the powdery cement-containing material in Example 1, referred to as “Powder raw material” in Table 14) of the mixture of the ground product of the fired product and flue-gas gypsum dihydrate, and ordinary Portland cement prepared in Example 1, and an alkaline earth metal-containing material of the kind shown in Table 14 and in the blending amount showed therein were mixed to provide a cement composition. In Example 16, two kinds of alkaline earth metal-containing materials were mixed.

In Table 14, the “Alkaline earth metal content ratio” is an alkaline earth metal content ratio (in terms of oxide) in the cement composition.

A sample was produced in conformity with “JIS R 5201:2015 (Physical testing methods for cement)” by using the obtained cement composition (referred to as “composition” in Table 14), fine aggregate, and water in the respective amounts shown in Table 14, removed from a mold, and then subjected to carbonation curing in a curing tank at a temperature of 30° C., a relative humidity of 60%, and a carbon dioxide concentration of 80 vol %. While the carbonation curing was performed, the compressive strength of the sample (hardened materials of the hydraulic composition) at an age of 7 days, and the bending strength at the time of an age of each of 3 days and 7 days were measured in conformity with “JIS R 5201:2015 (Physical testing methods for cement).”

Neutralization depths from sample side surfaces (four sides) of the sample at the time of an age of each of 3 days and 7 days having been subjected to carbonation curing in the same manner as the sample used for bending strength measurement were measured, and the average value thereof was taken as a neutralization depth (carbonation depth) value, in the same manner as in Example 4. In Table 14, “20.0 mm” indicates complete neutralization.

The results are shown in Table 15.

TABLE 14

| | | | | | Alkaline earth metal | | | | |
|---|---|---|---|---|---|---|---|---|---|
| | | | | | content ratio | | | | |
| | | | Alkaline earth metal- | | (in terms of oxide | | | | Fine |
| | | | containing material | | (mass %)) | | | Water | aggregate |
| | Water/ | Powder raw material | | (part(s) | | f•CaO- | | (part(s) | (part(s) |
| | composition | (part(s) by mass) | Kind | by mass) | Mg | derived | Total | by mass) | by mass) |
| Example | 0.5 | 416.2 | MgO | 33.8 | 7.5 | 0.3 | 7.8 | 225 | 1,350 |
| 15 | | | | | | | | | |
| Example | 0.5 | 427.5 | MgO | 11.3 | 2.5 | 0.3 | 3.6 | 213 | 1,350 |
| 16 | | | MgSO₄•7H₂O | 23.0 | 0.8 | | | | |

1) Amount (part(s) by mass) with respect to 100 parts by mass of powdery cement composition

TABLE 15

| | Compressive | | | | |
|---|---|---|---|---|---|
| | strength at | Bending | | Neutralization | |
| | 7 days | strength (N/mm²) | | depth (mm) | |
| | (N/mm²) | 3 days | 7 days | 3 days | 7 days |
| Example 15 | 53.5 | 11.5 | 11.6 | 20.0 | 20.0 |
| Example 16 | 56.9 | 10.3 | 13.1 | 20.0 | 20.0 |

From Table 11 and Table 15, it is found that the compressive strengths (53.5 N/mm² to 56.9 N/mm²) at an age of 7 days in Examples 15 and 16 are larger than the compressive strength (age of 7 days: 52.8 N/mm²) in Comparative Example 2 (in which none of the amine and the alkaline earth metal-containing material was used, and the curing conditions were the same as those in Examples 15 and 16).

It is found that the bending strengths (age of 3 days: 10.3 N/mm² to 11.5 N/mm²; age of 7 days: 11.6 N/mm² to 13.1 N/mm²) in Examples 15 and 16 are equal to or larger than the bending strengths (age of 3 days: 9.8 N/mm²; age of 7 days: 11.7 N/mm²) in Comparative Example 2.

From the neutralization depths in Examples 15 and 16, it is found that carbonation of the sample has reached the inside thereof.

1. A cement composition, comprising:
(A) a powdery cement-containing material containing
(i) Portland cement or a ground product of Portland cement clinker, and
(ii) a ground product of a fired product that contains 2CaO·SiO₂ and 2CaO·Al₂O₃·SiO₂ and satisfies the following conditions (1) and (2); and
(B) (iii) an amine:
(1) an amount of the 2CaO·Al₂O₃·SiO₂ is from 10 parts by mass to 100 parts by mass with respect to 100 parts by mass of the 2CaO·SiO₂; and
(2) the fired product is free of 3CaO·Al₂O₃ or contains 3CaO·Al₂O₃ in an amount of 15 parts by mass or less with respect to 100 parts by mass of the 2CaO·SiO₂.

2. The cement composition according to claim 1,
wherein the powdery cement-containing material contains (iv) an alkaline earth metal-containing material except for the component (i) and the component (ii), and
wherein a content ratio of an alkaline earth metal in the powdery cement-containing material is from 0.1 mass % to 10 mass % in terms of oxide, provided that only magnesium oxide, magnesium hydroxide, calcium oxide, and calcium hydroxide are included as the alkaline earth metal other than the alkaline earth metal included in the alkaline earth metal-containing material.

3. The cement composition according to claim 1, wherein an amount of the amine is from 0.001 part by mass to 5.0 parts by mass with respect to 100 parts by mass of the powdery cement-containing material.

4. The cement composition according to claim 1, wherein the amine is an alkanolamine.

5. The cement composition according to claim 1, wherein a content ratio of the ground product of the fired product in the powdery cement-containing material is from 10 mass % to 90 mass %.

6. A cement composition, comprising:
(i) Portland cement or a ground product of Portland cement clinker;
(ii) a ground product of a fired product that contains 2CaO·SiO₂ and 2CaO·Al₂O₃·SiO₂ and satisfies the following conditions (1) and (2); and
(iv) an alkaline earth metal-containing material except for the component (i) and the component (ii),
wherein a content ratio of an alkaline earth metal in the cement composition is from 0.1 mass % to 10 mass % in terms of oxide, provided that only magnesium oxide, magnesium hydroxide, calcium oxide, and calcium hydroxide are included as the alkaline earth metal other than the alkaline earth metal included in the alkaline earth metal-containing material:
(1) an amount of the 2CaO·Al₂O₃·SiO₂ is from 10 parts by mass to 100 parts by mass with respect to 100 parts by mass of the 2CaO·SiO₂; and
(2) the fired product is free of 3CaO·Al₂O₃ or contains 3CaO·Al₂O₃ in an amount of 15 parts by mass or less with respect to 100 parts by mass of the 2CaO·SiO₂.

7. The cement composition according to claim 6, wherein a content ratio of the ground product of the fired product in the cement composition is from 10 mass % to 90 mass %.

8. The cement composition according to claim 6, wherein the alkaline earth metal is magnesium (Mg).

9. The cement composition according to claim 6, wherein the alkaline earth metal is calcium (Ca).

10. A hydraulic composition, comprising:
the cement composition of claim 1;
water;
and aggregate;
wherein an amount of the water is from 25 parts by mass to 70 parts by mass with respect to 100 parts by mass of the powdery cement-containing material.

11. The hydraulic composition according to claim 10, wherein the hydraulic composition is a carbonated hardened materials obtained through carbonation curing.

12. A hydraulic composition, comprising:
the cement composition of claim 6;
water;
and aggregate;
wherein an amount of the water is from 25 parts by mass to 70 parts by mass with respect to 100 parts by mass of the cement composition.

13. The hydraulic composition according to claim 12, wherein the hydraulic composition is a carbonated hardened materials obtained through carbonation curing.

14. A method of producing the hydraulic composition of claim 11, the method comprising:
a kneaded product preparing step of preparing a kneaded product by using the materials for forming the cement composition, the water, and the aggregate, the kneaded product being a mixture thereof,
a placing step of placing the kneaded product into formwork;
a removing step of removing a hardened materials of the kneaded product from the formwork after the kneaded product in the formwork is hardened; and
a carbonation curing step of subjecting the hardened materials of the kneaded product removed from the formwork to carbonation curing to provide the carbonated hardened materials.

15. A method of producing the hydraulic composition of claim 13, the method comprising:
a kneaded product preparing step of preparing a kneaded product by using materials for forming the cement composition, the water, and the aggregate, the kneaded product being a mixture thereof,
a placing step of placing the kneaded product into formwork;
a removing step of removing a hardened materials of the kneaded product from the formwork after the kneaded product in the formwork is hardened; and
a carbonation curing step of subjecting the hardened materials of the kneaded product removed from the formwork to carbonation curing to provide the carbonated hardened materials.
